(19) United States
(12) Patent Application Publication
(10) Pub. No.: US 2011/0171355 A1
(43) Pub. Date: Jul. 14, 2011

(54) FOOD WARMING CABINET

(75) Inventors: TERRY TAE-IL CHUNG, BARTLETT, IL (US); JEFF SCHROEDER, LAKE ZURICH, IL (US)

(73) Assignee: PRINCE CASTLE, INC, CAROL STREAM, IL (US)

(21) Appl. No.: 12/686,499

(22) Filed: Jan. 13, 2010

(51) Int. Cl. A47J 27/00; A21B 2/00; F27D 11/00; F21V 9/06; A23L 1/01

(52) U.S. Cl. 426/234; 392/418; 392/416; 219/441; 392/408; 99/485

(57) ABSTRACT

A food warming cabinet keeps food warm and on display in serving trays using infrared heaters instead of hot water. The infrared heaters are located below the trays and direct IR at the trays. In an alternate embodiment, the IR heaters can also conduct heat into the trays. Using IR instead of water saves energy because it shortens warm-up time. Using IR also eliminates contaminated water and enables separate and individual temperature control of each tray. Tray temperature is maintained under computer control using contact or optical/IR temperature sensors.

### BACKGROUND

Prior art food warming cabinets or “steam tables” are well known. They are commonly found in restaurants and/or food service institutions that display foods for consumers to select from in that they hold food in open trays from which the food can be served.

Prior art steam tables are typically comprised of a cabinet having a some form of flat or planar countertop having one or more openings into which one or more open-top food serving trays are placed such that the tray bottoms are embedded within or just above a body of hot water held in an open tank or tub within the cabinet. The food temperature inside the tray is, therefore, determined by the temperature of the water held in the open tank, as well as ambient temperature as there is always a heat loss from the trays and water into the air above the trays. The water can be kept heated in some embodiments by an electrically-resistive heating element but maintaining the foods' temperature at a sufficiently high temperature to prevent spoilage is problematic.

Water has a relatively high specific heat. Prior art steam tables are therefore able to maintain relatively stable tray temperatures but keeping the water in the tank hot is inherently problematic because food in the trays should be kept at temperatures sufficiently high to prevent spoilage. Maintaining food tray temperatures inherently requires the water in the tank to be hot when the food-containing trays are first installed in the steam table and to thereafter be kept hot. Prior art steam tables, therefore, require a significant amount of starting energy to be input to the water, just to make it usable. Keeping the water sufficiently hot requires a heater within the steam table, which should operable in a closed room such as a restaurant serving area, i.e., electric, but which is also safe to use in an inherently wet environment.

Another problem with prior art steam tables, which use water in an open tank, is that the water itself eventually become contaminated with food products making them subject to contamination from food products that inevitably find their way in the tank. The tanks should be thoroughly cleaned on a regular basis.

Cleaning the water tanks in a steam table is problematic. The table must of course be taken out of service and the cleaning process requires the water to be drained, the tank sanitized and then re-filled with clean water.

Yet another problem with prior art steam tables is that the specific heat of water precludes the ability to quickly change the temperature in the food holding trays or to keep side-by-side trays at different temperatures. Prior art steam tables maintain foods at a single temperature, i.e. the temperature that the water can be heated to, which can never exceed 212° Fahrenheit or 100° Centigrade.

A food warming table or cabinet which overcomes the problems found in prior art steam tables would be an improvement over the prior art.

### BRIEF DESCRIPTION OF THE DRAWINGS

FIG. 1 is a perspective view of a food warming cabinet;

FIG. 2 is a cross-sectional diagram of the food warming cabinet shown in FIG. 1;

FIG. 3 is a perspective view of an electrically-powered infrared energy source;

FIG. 4 is a plan view of one embodiment of a planar infrared energy source; and

FIG. 5 is a plan view of an alternate embodiment of a planar infrared energy source.

### DETAILED DESCRIPTION

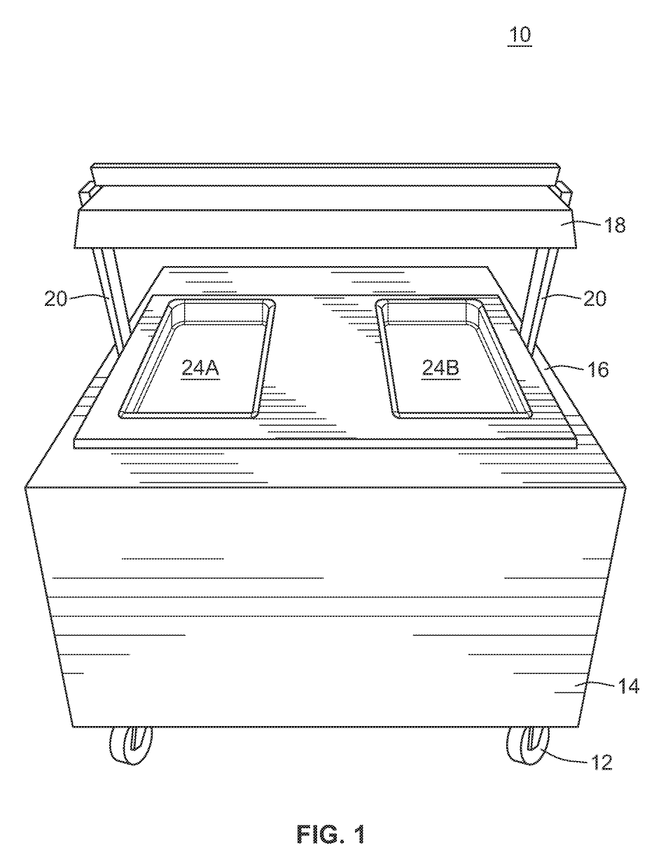

FIG. 1 is a perspective view of a food warming cabinet 10, comprised of a base 14 mounted on wheels 12, which enable the food warming cabinet 10 to be moved about. A top surface of the base 14 is provided with a countertop 16 into which rectangular openings are cut or formed to allow two stainless-steel serving trays 24A and 24B to inserted or held substantially within the base 14 of the cabinet 10. Alternate embodiments of the cabinet 10 include trays that have other shapes, including for instance, square, round, elliptical or triangular. For the sake of brevity, however, trays or pans of any shape are considered to be encompassed by the term, tray.

The trays are formed with a lip that rests on the top of the countertop 16, but which is not visible in FIG. 1. The trays 24A and 24B thus rest on the countertop 16 but are nevertheless substantially inside within the base 14.

Each tray has a substantially planar bottom. Since the trays are rectangular, they have four sidewalls that can be considered to extend upwardly from the planar bottom of each tray, substantially orthogonal thereto. The tray sidewalls define both a peripheral edge as well as periphery of the tray. The open tops enable food to be placed into the tray and removed from the tray. A sanitary hood 18 is supported above the trays 24A and 24B and the countertop 16 by two vertical posts 20.

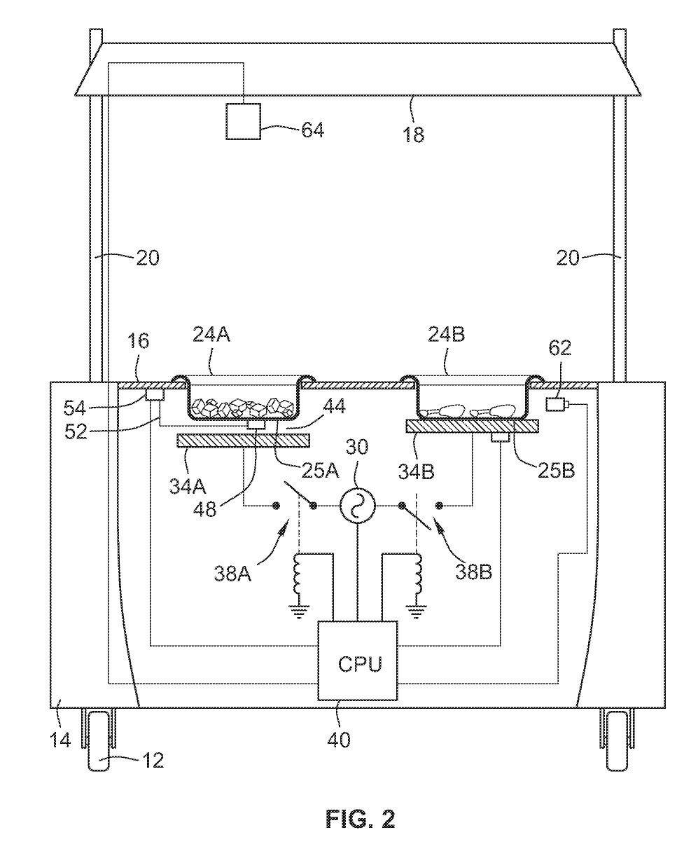

FIG. 2 is a cross-sectional view of the food warming cabinet shown in FIG. 1. FIG. 2 also depicts a functional block diagram of other apparatus within the cabinet 14.

Both food holding trays 24A and 24B have an electrically-powered infrared energy source or “IR source” 34A and 34B located directly below the trays' planar bottoms 25A and 25B respectively. The first tray bottom 25A is separated from the first IR source 34A by an air gap 44. The second tray bottom 25B is in direct physical contact with the second IR source 34B.

Infrared energy emitted from the electrically-powered infrared energy sources 34A and 34B is directed upwardly toward the food tray bottoms 25A and 24B. The IR energy is absorbed by the tray material, causing the temperature of the trays to rise. Stated another way, the IR heats the bottoms 25A and 25B of the trays and as a result, food items in the trays 24A and 24B. A distinct advantage of having two separate IR sources 34A and 34B to heat corresponding trays 24A and 24B is that the temperature of the corresponding trays can be different from each other and individually controlled.

By way of example, a first tray 24A can be maintained at or near a first temperature, within a first temperature range between one-hundred eighty and two-hundred degrees Farenheit. The second tray 24B can be maintained at a second temperature, greater than the first temperature, within a second temperature range between one-hundred ninety and two-hundred degrees.

Tray temperatures can be individually controlled and kept within different or the same temperature ranges using tray temperature information obtained from one or more temperature sensors 48 thermally coupled to different trays 24A and/or 24B. The sensors 48 are preferably embodied as thermistors and/or semiconductors in direct contact with either the bottom or sides of the trays. Such devices are well-known in the electronic art and provide a resistance or voltage proportional to temperature.

In FIG. 2, a single temperature sensor 48 is depicted as being in direct thermal contact with the bottom 25A of the first tray 24A using an articulated leaf spring 52, one end of which is attached to the underside of the countertop 16. The spring 52 is sized, shaped and arranged to extend downward from the underside of the countertop 16, bend and extend underneath the tray 24A. The spring 52 is thus configured to hold the temperature sensor 48 against the bottom 25A of the tray 24A.

The spring 52 is sized, shaped and arranged to deflect upwardly and downwardly as needed, according to the depth of the food tray 24A but to hold the sensor 48 against the bottom 25A of the tray 24A whenever the tray 24A is in the cabinet 10. Electrical connections to the spring-mounted sensor 48 are provided via conductors that are carried over the leaf spring 52 from a connector block 54.

Wires extend from the connector block 54 to a central processing unit or CPU 40, which is programmed to read the signals from the temperature sensor 48. The CPU 40 thereafter adjusts electric power provided to the planar infrared energy source 34A that provides heat energy to the tray 24A by opening and closing a software-controlled solenoid 38A. The solenoid 38A is electrically coupled to an electrical energy source 30, typically embodied as ordinary line voltage.

While the left-side tray 24A is separated from the IR sources 34A by an air gap 44, the right-hand side food holding tray 24B is depicted as having its bottom surface 25B in direct contact with a second, substantially planar infrared energy source 34B. In such an embodiment, the tray bottom 25B receives thermal energy directly from the energy source 34B. Since the tray 24B is metal and therefore thermally conductive, heat provided into the tray bottom 25B is readily conducted through-out the tray and into food stuffs inside the tray.

Sensing the temperature of the tray 24B and/or food within the tray 24B can be difficult if a direct sensor is to be used. In at least one alternate embodiment, tray temperature and the tray's contents temperature is measured using an optical temperature sensor 62 positioned inside the base 14 and directed to an exterior surface of a tray. In another alternate embodiment, an optical infrared energy sensor 64 is mounted to the underside of the hood 18 and positioned above one or more of the food holding trays 24 in order to measure the tray temperature by the amount of IR radiated from the tray contents or the tray bottom if the tray is empty or nearly empty. In embodiments that use optical/IR sensors, the sensors detect infrared emitted from the trays, the tray contents or tray surfaces, such as the sensor 62 inside the cabinet base 14. The sensors 62 and 64 are configured to send a corresponding temperature-indicative signal to the CPU 40. The CPU 40 thereafter modulates the current provided to a corresponding planar IR heating source 34A and/or 34B responsive to the measured temperature of a tray. The tray temperature is thus controlled by monitoring emitted IR.

In yet a third alternate embodiment, tray temperature can be inferred from the temperature of the planar IR heat sources 34A or 34B. In FIG. 2, a temperature sensor 48 can also be attached to the underside or top side of a planar infrared energy source 34B as shown.

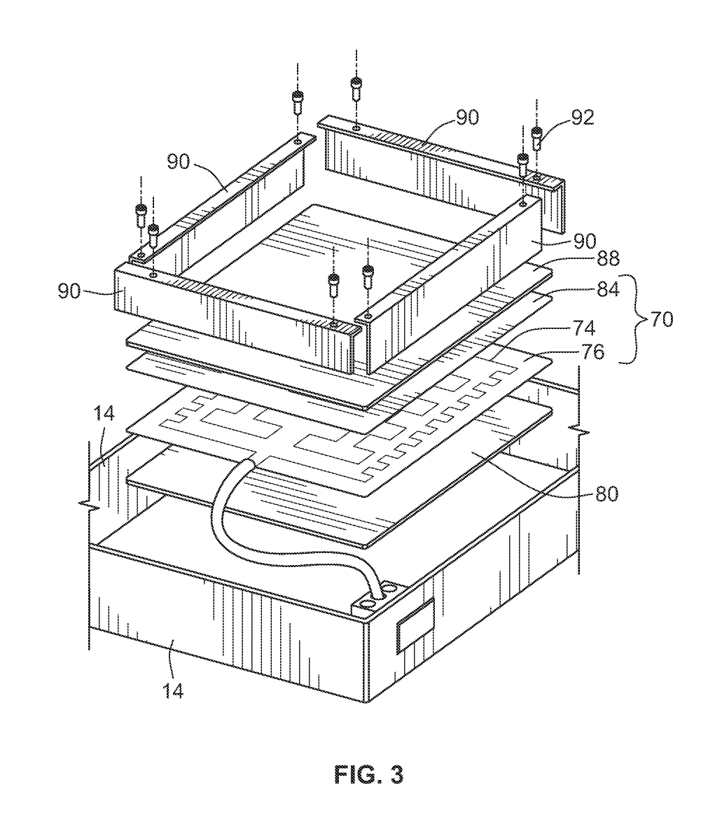

FIG. 3 is an exploded view of a planar infrared heating element 70 used in the food warming cabinet 10 shown in FIG. 1 and FIG. 2. The planar heater 70 is comprised of an electrically-resistive heating element wire (wire) 74, preferably bonded to a thermally and electrically insulating substrate 76. The wire 74 is laid down on the substrate 76 with a predetermined pattern in order to optimally heat the trays 24 and their contents.

The insulating substrate 76, which carries the heating wire 74, laid on top of a rigid metal support substrate 80. The support substrate 80 maintains the planarity of the substrate 76, which prevents the heater wire 74 from fracturing.

An infrared-transmissive front layer 84 is attached to the top side of the substrate 76 using an appropriate adhesive placed around the perimeter of the substrate 76. The IR transmissive front layer 84 protects the heating element wire 74 from mechanical damage and reduces the likelihood of an electrical short circuit due to a liquid coming into contact with the wire. An optional second infrared transmissive layer 88 can be used and provided with an ultraviolet filter to screen or shield the transmission of ultraviolet light. The second infrared-transmissive glass which optionally includes a UV filter layer provides a cleanable surface.

As mentioned above, a bottom 25 of a tray 24 can be separated from a planar infrared energy source 70 by an infrared-transmissive material or layer, such as air, quartz or glass. As was also mentioned, a tray bottom can be in direct contact with the infrared energy source 70. In one alternate embodiment, a thermally conductive material, e.g., metal, is located between the energy source 70 and the tray bottom 25 to provide heat to the tray using conduction instead of radiation. In another alternate embodiment, an IR partially transmissive material is placed in the air gap 44 such that heat is transferred into a tray 25 by radiation and conduction.

The type of material between the energy source 70 and tray bottom 25 can be determined in part by the gap 44 or spacing between the tray bottoms 25 and the infrared energy source 70. The gap 44 is effectuated by the dimensions of a metal frame 90 attached to the underside of the countertop 16 by fasteners 92. As the vertical dimension of the metal frame 90 is increased, the infrared energy source 70 will be farther from the underside of the trays 25.

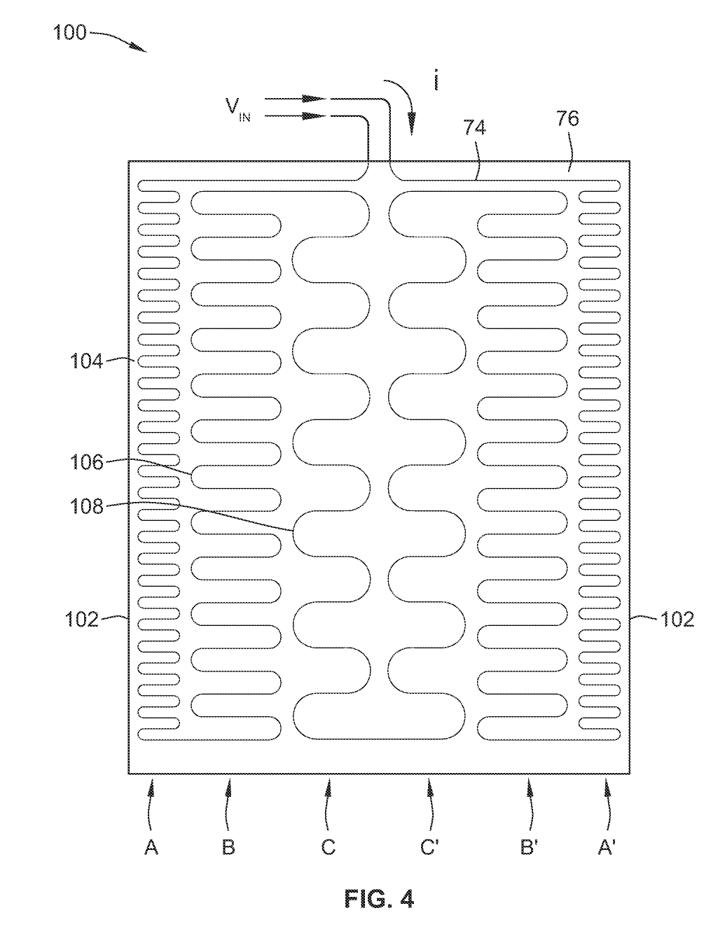

FIG. 4 shows one embodiment of a wire layout on a substrate 76. In FIG. 4, the infrared energy source wire 74 is arranged in several rows, each of which is comprised of several boustrophedonic rows or patterns 104, 106 and 108. The rows of boustrophedons identified by the letters A, B, C, C′, B′ and A′ identify boustrophedons of three different widths or pitch and which are themselves identified by reference numerals 104, 106 and 108.

As can be seen in the figure, the boustrophedons of rows A and A′ and which are closest to the outside lateral edges 102, are spaced more closely than are the boustrophedons or loops of rows B and B′. Similarly, the boustrophedons of rows B and B′ are spaced more closely than are the boustrophedons or loops of rows C and C′

Winding the electrically-resistive material as shown in FIG. 4 imbues the planar heating element 100 with an infrared emission pattern wherein the concentration of emitted IR is greater around the perimeter and along the edges 102 than is the IR emitted in the middle or central areas of the heating element 100. By weighting the emitted infrared energy more heavily at the edges of the heating element 100, a greater amount of infrared energy is emitted toward the corresponding peripheral edges of the food holding trays than is emitted toward interior areas of the food holding trays. Stated another way, the closer and more-numerous windings of resistive material 74 near the edges 102 emit more IR than do the more widely-spaced and less numerous windings near the interior areas. The greater IR emitted from around the periphery of the heating element 100 transfers a correspondingly greater amount of heat energy into the periphery of the trays.

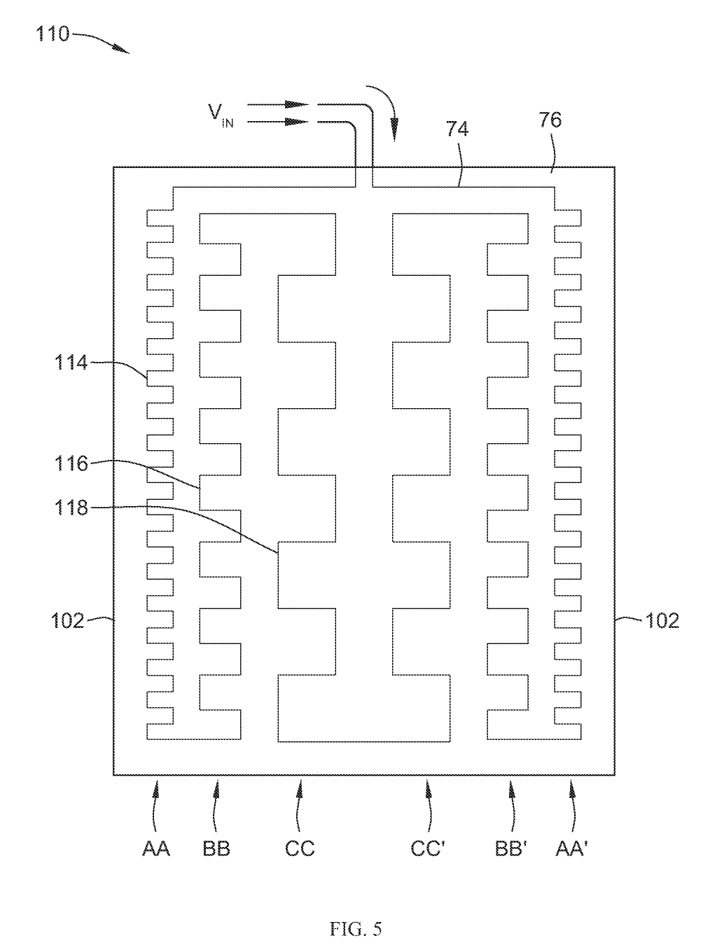

Referring now to FIG. 5, there is shown an alternate embodiment of a planar infrared heating element 110. In this figure, the electrically-resistive heating element material 74, which is also applied to a thermally and electrically-resistive substrate 76 is laid down in crenellate patterns. The crenellations of the rows AA and AA′ and which are adjacent to the lateral edges 102, are more numerous and closer to each other than are the crenellations for rows BB and BB′. The more-closely spaced crenellations around the lateral edges 102 thus imbue the heating element 110 with the substantially the same characteristic described above for the heating element 100 shown in FIG. 4, namely the ability to concentrate more emitted infrared energy at the lateral edges of the trays 25 than would otherwise be possible.

Those of ordinary skill in the art will recognize that the structure described above and shown in the figures lends itself to a method of heating food in a tray held in a food warming cabinet 10. That method includes simply upward toward the bottom of the tray such that the amount of infrared energy per unit area that is directed along the peripheral sides or edges of the tray is greater than the infrared energy directed to the interior of the tray. By directing the infrared energy as such, thermal losses, which occur more at the tray periphery than in the center can be compensated for the amount of heat energy being input.

The infrared energy concentration at the periphery of the tray edges can be effectuated using either boustrophedonic or crenellated rows of electrically-resistive material through which an electric current I is passed.

The foregoing description is for purposes of illustrations only. The true scope of the invention is set forth in the appurtenant claims.

What is claimed is:

1. A food warming cabinet comprising:
a base;
at least one food holding tray (tray) having a bottom, an open top and a peripheral edge that defines a periphery of said tray, the tray being supported by, and at least partially within, said base; and
an electrically-powered infrared energy source located below the tray, within the base, and directing infrared energy toward the bottom of the tray.

2. The food warming cabinet of claim 1, further comprised of a layer of infrared-transmissive material between at least part of the bottom of the tray and at least part of the electrically-powered infrared energy source.

3. The food warming cabinet of claim 1, further comprised of at least one of:
infrared-transmissive material between at least a first part of the bottom of the tray and at least a first part of the electrically-powered infrared energy source; and
thermally-conductive material between, and in thermal contact with, at least a second part of the bottom of the tray, and in thermal contact with, a second part of the electrically-powered infrared energy source.

4. The food warming cabinet of claim 1, wherein the infrared energy source is substantially planar.

5. The food warming cabinet of claim 1, further comprised of a temperature sensor thermally coupled to at least one of:
the at least one food holding tray; and
the air gap;
the temperature sensor being operatively coupled to a power controller for the electrically-powered infrared energy source.

6. The food warming cabinet of claim 5, wherein the temperature sensor is a semiconductor.

7. The food warming cabinet of claim 5, wherein the temperature sensor is an optical temperature sensor.

8. The food warming cabinet of claim 4, wherein the substantially planar infrared energy source is configured to direct infrared energy upwardly, toward the bottom of the at least one food holding tray in a predetermined emission pattern by which a larger amount of infrared energy emitted from the planar infrared energy source is directed to the periphery of the at least one food holding tray than is directed to the interior of the at least one food holding tray.

9. The food warming cabinet of claim 4, wherein the planar infrared energy source is comprised of a plurality of layers, a first layer being a support layer, a second layer over the first layer and comprised of a length of electrically-resistive material supported on a rectangular and non-conductive substrate, a third layer being an IR transmissive layer that is over the second layer.

10. The food warming cabinet of claim 4, wherein the planar infrared energy source is comprised of a length of electrically-resistive material supported on a rectangular and non-conductive substrate, the electrically-resistive material having at least one boustrophedonic pattern that is adjacent to and which extends along at least two opposing sides of the substrate.

11. The food warming cabinet of claim 4, wherein planar infrared energy source is comprised of a length of electrically-resistive material supported on a rectangular and electrically non-conductive substrate, the electrically-resistive material having a plurality of rows, at least one row having a boustrophedonic pattern.

12. The food warming cabinet of claim 11, wherein at least one row adjacent to a side of the substrate, has a boustrophedonic pattern, the loops of which are spaced more closely to each other than the loops of a second boustrophedonic row adjacent the first row.

13. The food warming cabinet of claim 4, wherein the substantially planar infrared energy source is comprised of a length of electrically-resistive material supported on a rectangular and non-conductive substrate, the electrically-resistive material having at least one crenellated pattern the crenellations of which have a first spacing between them and which extend along at least one side of the substrate.

14. The food warming cabinet of claim 13, wherein the plurality of crenellated rows include at least one row adjacent a side of the substrate, the crenellations of which are spaced more closely to each other than the crenellations of a second crenellated row adjacent the first row.

15. The food warming cabinet of claim 4, wherein the density of the infrared energy directed at the center of the at least one food holding tray is less than the density of the infrared energy directed toward the periphery of the at least one food holding tray.

16. The food warming cabinet of claim 4, wherein the substantially planar infrared energy source includes a UV-suppressive filter.

17. The food warming cabinet of claim 4, wherein the substantially planar infrared energy source is a reduced UV heater.

18. The food warming cabinet of claim 4, wherein the at least one food holding tray is stainless steel.

19. The food warming cabinet of claim 1, further comprised of a protective hood at least partially covering the at least one food holding tray.

20. The food warming cabinet of claim 19, wherein the hood is comprised of at least one optical temperature sensor.

21. A method of heating food in a tray in a food warming cabinet, the cabinet having a base that supports a tray having a bottom and at least three sides, the method comprising the steps of:
directing infrared energy upwardly toward the bottom of the tray such that the amount of infrared energy per unit area directed along the sides of the tray is greater than the infrared energy per unit area that is directed to the interior of the tray.

22. The method of claim 21, wherein the infrared energy is emitted from electrically resistive material formed into a plurality of boustrophedonic rows.

23. The method of claim 21, wherein the infrared energy is emitted from electrically resistive material formed into a plurality of crenellated rows.

24. A food warming cabinet comprising:
a base;
first and second food holding trays, and
first and second electrically-powered infrared energy sources located below the first and second food holding trays respectively, the first and second electrically-powered infrared energy sources being configured to maintain the first and second food holding trays at first and second different temperatures, the first and second different temperatures being within first and second different temperature ranges.

25. The food warming cabinet of claim 24, wherein the first and second temperature ranges overlap.

26. A food warming cabinet comprising:
a base;
a food holding tray,
an infrared energy source located below the food holding tray and configured to provide thermal energy to the food holding tray;
an optical temperature sensor, operatively coupled to the food holding tray;
a controller, operatively coupled to the optical temperature sensor and to the infrared energy source, the controller being configured to control electrical energy to the infrared energy source in response to a signal received from the one optical temperature sensor.

27. The food warming cabinet of claim 26, wherein the optical temperature sensor detects infrared energy.
